(19) United States
(12) Patent Application Publication
(10) Pub. No.: US 2021/0301780 A1
(43) Pub. Date: Sep. 30, 2021

(54) DEVICE FOR ADJUSTING WATER FLOW AND WATER TURBINE MACHINE USING THE SAME

(71) Applicant: Jung-Yi Lai, Keelung City (TW)

(72) Inventor: Jung-Yi Lai, Keelung City (TW)

(21) Appl. No.: 17/210,175

(22) Filed: Mar. 23, 2021

(30) Foreign Application Priority Data
Mar. 30, 2020 (TW) 109110788

(51) Int. Cl. F03B 15/06; F03B 1/00

(52) U.S. Cl. CPC F03B 15/06; F03B 1/00

(57) ABSTRACT

A flow channel adjusting device comprises a flow channel having an inlet and a nozzle outlet corresponding to a water turbine machine, and an adjusting device for adjusting opening dimension of the nozzle outlet, comprising a driving unit, a pivoting part, and a following part. The pivoting part has a first side rotatably coupled to a first rotating element, and is driven to rotate by the driving unit for adjusting the opening dimension of the nozzle outlet. The following part has a third side rotatably coupled to a second side of the pivoting part, and a fourth side rotatably coupled to a second rotating element which translates along a second axis perpendicular to the first axis when the pivoting part is driven to rotate. The flow channel adjusting device could be utilized in water turbine machine and generator using the water turbine for adjusting amount of water flow.

This application claims the benefit of Taiwan Patent Application Serial No. 109110788, filed on Mar. 30, 2020, the subject matter of which is incorporated herein by reference.

### BACKGROUND OF INVENTION

### 1. Field of the Invention

The present invention is related to a water turbine machine, and more particularly, to a device for adjusting water flow and water turbine machine using the same.

### 2. Description of the Prior Art

The cross-flow water turbine machine can be operated under low-head condition with slightly larger water flow. Unlike the most radial or axial type of water turbine machine, the water stream directly passes through the blades of turbine, i.e. water stream flowing into the turbine at a small angle in the tangential direction from a lateral side of the water wheel, and flowing out of the water wheel from gap between blades at opposite side of water wheel. In addition to the impact force when the water stream flows into the water wheel, the secondary impact force on the water wheel will be generated while the water stream flows out of the water wheel. The inward-flow water turbine machine is designed by Dr. Banki Donat, USA, and is patented as U.S. Pat. No. 1,436,933 in 1919. After that, other competitor improved the original design and patented as U.S. Pat. No. 4,579,506, and then a cross-flow type of water turbine machine was developed and was successfully released to the commercial market.

Please refer to the FIG. 1, which illustrates a fundamental structure of conventional Banki-type cross-flow water turbine machine disclosed in the U.S. Pat. No. 4,579,506A. In this water turbine machine, water flow 90 passes through a flow controlling plate 11 and then enters into the water wheel 10. The flow controlling plate 11 is utilized to control the amount of water flow entering into the water wheel. In the water turbine machine shown in the FIG. 1, the water wheel 10 is driven to rotate according the pressure difference generated between the water inlet and nozzle outlet. Since the water wheel is a horizontal-axis water wheel, the water flow will flow downward after passing the water wheel thereby exposing the water wheel under the air environment. In the structure shown in FIG. 1, the flow controlling plate 11 is driven by oil pressure pump and operation efficiency is around 83%.

Please refer to FIG. 2, which illustrates another conventional cross-flow water turbine, wherein the flow controlling plate 13 arranged at a side of the water wheel is utilized to control amount of the water flow entering the water wheel 10 by a pivotal rotation. In the conventional water turbine shown in FIG. 2, although the flow controlling plate 13 is simplified to control the dimension of inlet opening allowing the water flow entering into the water wheel 10, the movement of the flow controlling plate 13 is not smooth toward the flowing direction of the water flow so that the operation efficiency is only around 77%.

According to the drawbacks of the conventional arts, there is a need to design new water turbine machine for efficiently and smoothly adjusting the dimension of inlet opening so as to improve the efficiency of the water flow entering the water wheel.

### SUMMARY OF THE INVENTION

The present invention provides a device for adjusting water flow entering the water wheel, in which a pivoting part is arranged at a side of the nozzle flow channel whereby the opening dimension or size of a nozzle outlet of the nozzle flow channel can be changed by a rotating angle of the pivoting part so as to control amount of water flow entering into the water wheel. In addition, the pivoting part is driven through a simplified mechanism for changing the opening dimension of the nozzle outlet. Since the pivoting part is arranged at a side of the water wheel, the flow direction of the water flow can be smoothly maintained.

In one embodiment, the present invention provides a device for adjusting a water flow flowing into a water wheel, and the device comprises a nozzle flow channel, and an adjusting device, wherein the nozzle flow channel has an inlet and a nozzle outlet corresponding to a part of the water wheel, and the adjusting device is arranged at a side of the nozzle flow channel for adjusting a dimension of the nozzle outlet. In one embodiment, the adjusting device further comprises a pivoting part, a following part, and a driving part. The pivoting part has a first side coupled to a first rotating element through which the pivoting part rotates about a first axial direction for adjusting the dimension of the nozzle outlet. The following part has a third side rotatably coupled to a second side of the pivoting part, and a second rotating element arranged at a fourth side of the following part, wherein the second rotating element further moves along a second axial direction perpendicular to the first axial direction when the pivoting part changes the opening dimension of the nozzle outlet. The driving unit is utilized to generate a driving force for rotating the pivoting part.

In one embodiment, the present invention further provides a water turbine comprising a water wheel, a nozzle flow channel, and an adjusting device. The water wheel is arranged inside a housing, and has an axial shaft arranged along a first axial direction, whereby the water wheel rotates about the first axial direction. The nozzle flow channel has an inlet and a nozzle outlet corresponding to a part of the water wheel. The adjusting device arranged at a side of the nozzle flow channel for adjusting an opening dimension of the nozzle outlet further comprises a pivoting part, a following part, and a driving part. The pivoting part has a first side coupled to a first rotating element through which the pivoting part rotates about the first axial direction for adjusting the dimension of the nozzle outlet. The following part has a third side rotatably coupled to a second side of the pivoting part, and a second rotating element arranged at a fourth side of the following part, wherein the second rotating element further moves along a second axial direction perpendicular to the first axial direction when the pivoting part changes the opening dimension of the nozzle outlet. The driving unit is utilized to generate a driving force for rotating the pivoting part.

### BRIEF DESCRIPTION OF THE DRAWINGS

The present invention will now be specified with reference to its preferred embodiment illustrated in the drawings, in which:

FIG. 1 illustrates a fundamental structure of conventional Banki-type cross-flow water turbine machine.

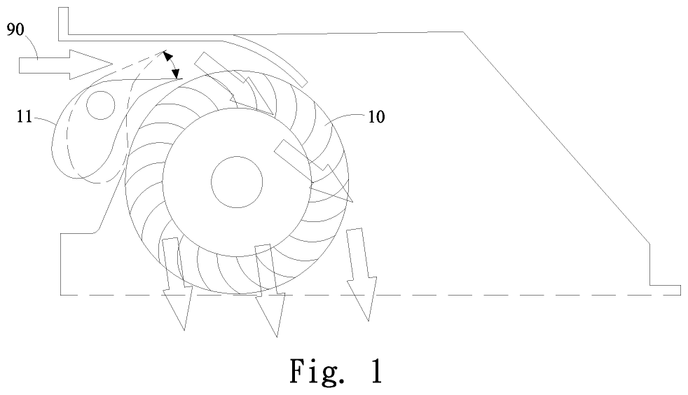

FIG. 2 illustrates a fundamental structure of cross-flow water turbine having flow controlling plate for adjusting amount of water flow.

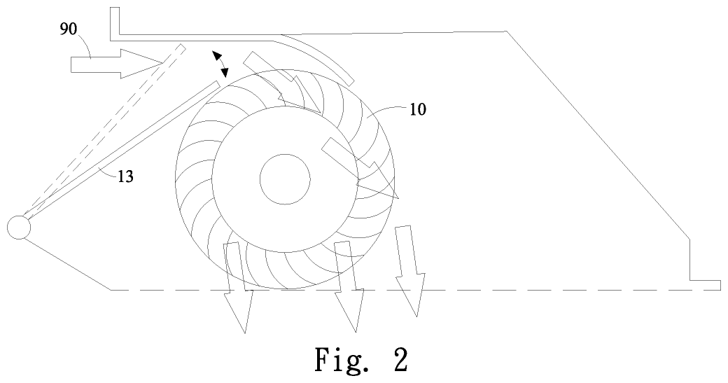

FIG. 3A illustrates a cross-sectional view of water turbine machine according to one embodiment of the present invention.

FIG. 3B illustrates one embodiment of adjusting the dimension of nozzle outlet in the water turbine machine shown in FIG. 3A.

FIG. 4 illustrates a perspective view pivoting part and following part according to one embodiment of the present invention.

FIGS. 5A and 5B illustrate a driving unit according to one embodiment of the present invention.

FIG. 6 illustrates a horizontal-axis cross-flow water turbine machine according to one embodiment of the present invention.

FIG. 7A illustrates a vertical-axis cross-flow water turbine machine according to one embodiment of the present invention.

FIG. 7B illustrates a cross-sectional view along the XY plane of the vertical-axis cross-flow water turbine machine according to one embodiment shown in FIG. 7A.

### DESCRIPTION OF THE PREFERRED EMBODIMENT

The invention disclosed herein is directed to device for cultivating cell and method of making the same. In the following description, numerous details corresponding to the aforesaid drawings are set forth in order to provide a thorough understanding of the present invention so that the present invention can be appreciated by one skilled in the art, wherein like numerals refer to the same or the like parts throughout.

Although the terms first, second, etc. may be used herein to describe various elements, components, modules, and/or zones, these elements, components, modules, and/or zones should not be limited by these terms. Various embodiments will now be described in conjunction with a number of schematic illustrations. The embodiments which are set forth the device for cultivating cells and method for making the same are different from the conventional approaches. Various embodiments of the application may be embodied in many different forms and should not be construed as a limitation to the embodiments set forth herein.

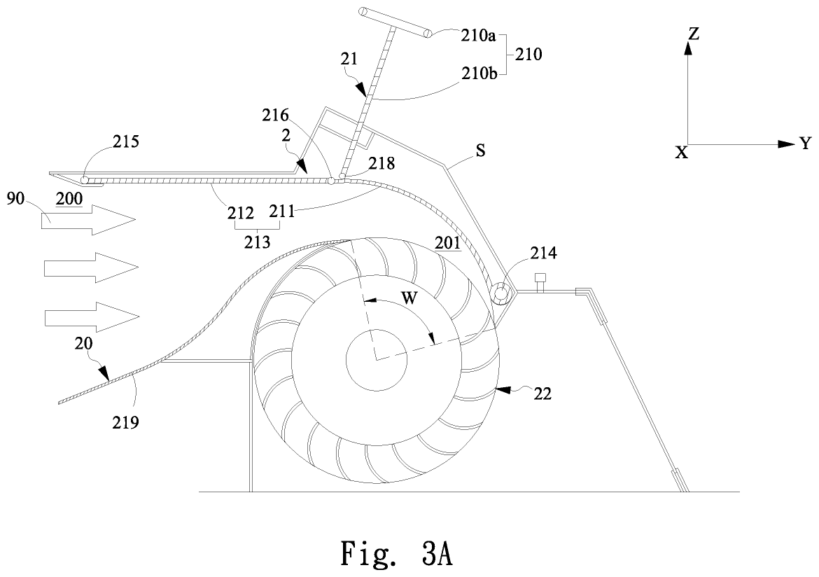

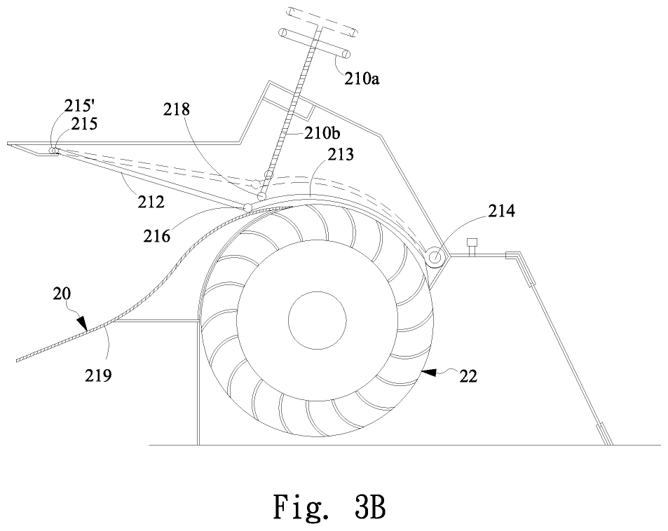

Please refer to FIG. 3A, which illustrates a water turbine machine having device for adjusting water flow according to one embodiment of the present invention. In the present embodiment, the device 2 comprises a nozzle flow channel 20 defined by a upper guiding plate 213 and lower guiding plate 219, and an adjusting device 21. The nozzle flow channel 20 comprises a water inlet 200, and a nozzle outlet 201 having an opening dimension corresponding to a part W of the water wheel 22. In the present embodiment, the water wheel 22 is a cross-flow water wheel arranged in the water turbine machine.

The adjusting device 21 is utilized to adjust the opening dimension of nozzle outlet 201 thereby controlling amount of the water flow entering into the part W of water wheel 22 from the nozzle outlet 201. In the present embodiment, the adjusting way is different from the conventional techniques. In the present embodiment, the nozzle outlet 201 is adjusted by adjusting the location of upper guiding plate 213. The adjusting device 21 comprises a driving unit 210, a pivoting part 211 and a following part 212, wherein the pivoting part 211 and the following part 212 are partially or completely formed the upper guiding plate 213. In the present embodiment, the upper guiding plate 213 is formed by the pivoting part 211 and the following part 212. The driving unit 210 is a lead screw module having a handle 210a and a lead screw 210b connected to the handle 210a. In the present embodiment, the lead screw 210b is threadedly engaged with the housing S of the water turbine machine, wherein one end of the lead screw 210b passes through the housing S and pivotally coupled to the pivoting part 211. The handle 210a is counterclockwise or clockwise turned to downwardly or upwardly move the lead screw 210b thereby adjusting the location of the pivoting part 211.

The pivoting part 211 is coupled to the driving unit 210 and comprises a first rotating element 214 arranged at a first side of the pivoting part 211 along a first axis X direction. In the present embodiment, the pivoting part 111 rotates about the first axis X direction through the first rotating element 214 in response to the turning motion of the driving unit 210 thereby adjusting the opening dimension or opening size of the nozzle outlet 201. In the present embodiment, one end of the lead screw 210b of the driving unit 210 is pivotally engaged with the pivoting part 211. The following part 212 has a third side pivotally engages with a second side of the pivoting part 211. In the present embodiment, the following art 212 engages with the pivoting part 211 through a pivot element whereby a relative rotation is established between the pivoting part 211 and the following part 212.

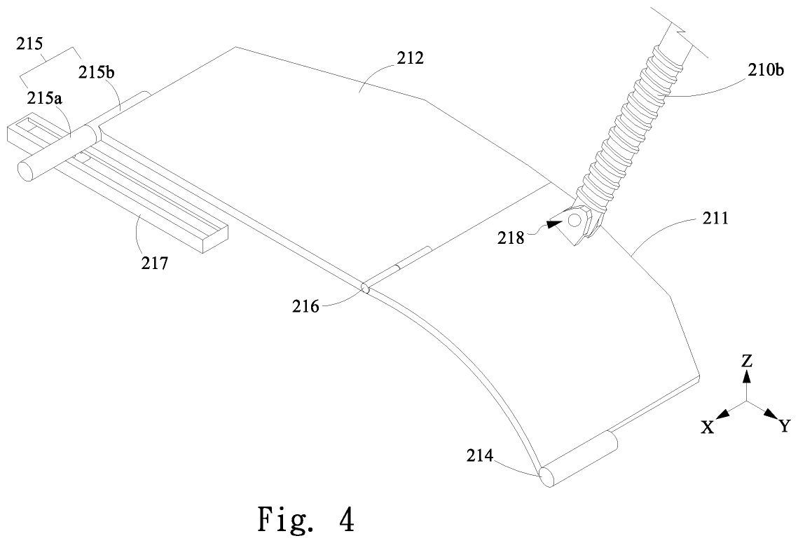

The following part 212 further has a fourth side on which a second rotating element 215 is arranged, wherein the second rotating element 215 performs a linear movement along a second axis Y direction perpendicular to the first axis X direction when the pivoting part 211 is rotated to change the dimension of the nozzle outlet 201. Please refer to FIG. 4, in one embodiment, the second rotating element 215 is slidably engaged with a rail 217 and further comprises an axial sleeve 215a and an axial element 215b, wherein the axial sleeve 215a is slidably engaged with the rail 217 whereby the axial sleeve 215a can linearly slide along the rail 217. The axial element 215b is pivotally coupled to the axial sleeve 215a such that the axial element 215b is capable of performing a rotation in the axial sleeve 215a when the pivoting part 211 is rotated. The axial element 215b is connected to the following part 212. When the following part 212 is rotated in response to the rotation of the pivoting part 211, in addition to the rotation of the second rotating element 215, the second rotating element 215 also slides along the rail 217 in the meantime. In one embodiment, the pivoting part 211 has an pivotal base 218 pivotally coupled to the end of the lead screw 210b.

Please refer to FIGS. 3A and 3B, when the handle 210a is clockwise turned, the lead screw 210b is followed to turn clockwise. In the turning motion of the lead screw 210b, the end of the lead screw 210b is linearly moved to push the pivoting part 211 moving downwardly. Since the first side of the pivoting part 211 has the first rotating element 214, when the pivoting part 211 is driven by the lead screw 210b to move downwardly, the first side of the pivoting part 211 rotates counterclockwise through the first rotating element 214 whereby the opening dimension of the nozzle outlet 201 can be adjusted. If the lead screw 210b is turned continuously, the pivoting part 211 will completely close nozzle outlet 201 which is illustrated as the status shown in FIG. 3B. In the present embodiment, the pivoting part 211 has a curved part having a curvature corresponding to a partial part W of the water wheel 22. the pivoting part 211 is capable of completely covering the nozzle outlet 201 so as to prevent the water flow flowing into the water wheel 22.

In addition, during the pivoting part 211 rotating counterclockwise, since the following part 212 is pivotally engaged with the pivoting part 211 at the third side, the following part 212 will also be driven to move downwardly. During the following part 212 moving downwardly, the second rotating element 215 arranged at the fourth side of the following part 212 will perform movement having two degree of freedom, wherein the following part 212 clockwise rotates through the second rotating element 215 while the second rotating element 215 will slide along the positive second axis Y direction in the meantime whereby the channel width of the nozzle flow channel 20 is gradually narrowed thereby reducing the opening size of the nozzle outlet 201. On the contrary, when the handle 210a is turned counterclockwise, the lead screw 210b is followed to turn counterclockwise whereby the lead screw 210b moves upwardly to pull the pivoting part 211 to move along the third axis Z direction. In the condition, the pivoting part 211 clockwise rotates about the first axis X direction by the first rotating element 214 while the following part 212 counterclockwise rotates about the second axis Y by the second rotating element 215 which also linearly moves along negative second axis Y direction in the meantime.

It is noted that the driving unit 210 is not limited to the embodiment having lead screw 210b, and handle 210a shown in 3A. Alternatively, the handle 210a can be replaced with a combination of motor and gears for automatically generating power transferring to the lead screw 210b whereby the lead screw 210b can be rotated clockwise or counterclockwise in response the rotating direction of the motor. The combination of motor and gear is well-known by the one having ordinary skilled in the art, which will not be described hereinafter.

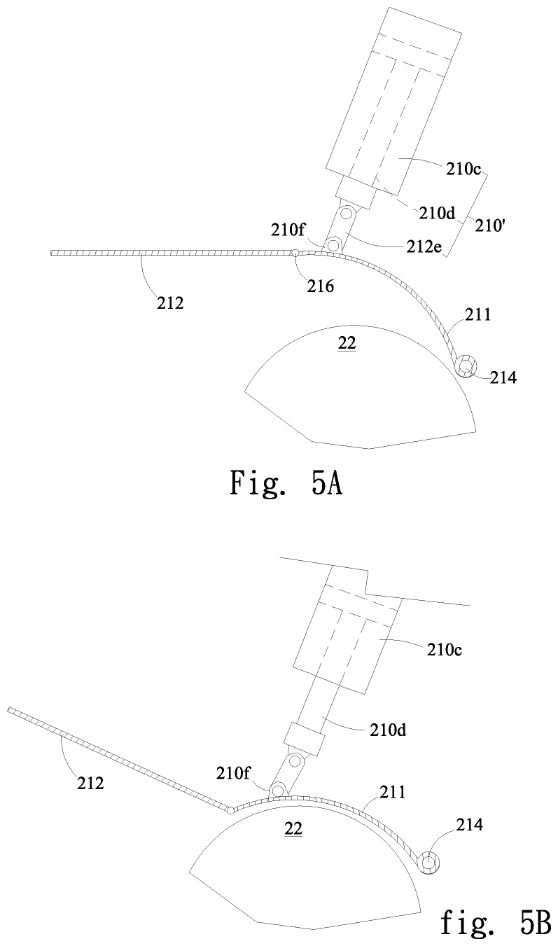

In addition, please refer to FIGS. 5A and 5B, which illustrate another embodiment of the driving unit. In the present embodiment, the driving unit 210′ comprises a power unit 210c, a push rod 210d, and a connecting rod 210e. The power unit 210c can be hydraulic cylinder, such as oil cylinder, for example, or pneumatic cylinder for providing driving power through liquid or gas. The push rod 210d is coupled to the power unit 210c. In the present embodiment, the push rod 210d is available to move within the power unit 210c, i.e. extending forwardly to protrude from the power unit 210c or returning backwardly into the power unit. The connecting rod 210e has one end coupled to the push rode 210d and the other end pivotally coupled to the pivoting part 211 through a pivot base 210f.

Please refer to FIG. 5B, when it comes to reduce the size of the nozzle outlet 201 above the water wheel 22, the push rod 210d moves forwardly by controlling the gas or liquid moving in/out the power unit 210c so that the push rod 210d generates a push force acting onto the pivoting part 211 whereby the pivoting part 211 counterclockwise rotates about the rotating axis of the first rotating element 214 thereby adjusting the opening size of the nozzle outlet 201 above the water wheel 22 so as to adjust the water flow entering into the water wheel 22. On the contrary, as illustrated in FIG. 5A, when it comes to increase the size of the nozzle outlet 201, the push rod 210d moves backwardly by controlling the gas or liquid moving in/out the power unit 210c so that the push rod 210d generates a pull force acting onto the pivoting part 211 whereby the pivoting part 211 clockwise rotates about the rotating axis of the first rotating element 214 thereby increasing the size of the nozzle outlet 201 above the water wheel 22 so as to increase the water flow entering into the water wheel 22. The objective for adjusting the size of the nozzle outlet 201 is that when the amount of water flow coining from the water source is varied, the size of the nozzle outlet 210 can keeps water level at the upstream side at a certain height thereby increasing the potential energy for generating electrical power.

In addition, it is also noted that either the way of lead screw or the way of push rod, the principle of these design is utilized to generate an acting force onto the pivoting part 211 so that the pivoting part 211 can counterclockwise rotate or clockwise rotate. However, the way for driving the pivoting part 211 is not limited to the above-mentioned embodiments. For example, in addition to providing force acting onto the pivoting part 211, it is also available to provide actuate force acting onto the following part 212. Alternatively, in another embodiment, the driving unit 210 is also capable of proving force acting onto the second rotating element 215 whereby the following part 212 moves along the rail 217 so as to rotating the pivoting part 211.

For example, the lead screw 210b or push rod 210d is utilized to generate actuating force onto the second rotating element 215 so that the second rotating element 215 is capable of performing a linear movement forwardly or backwardly thereby driving the rotation of the following part 212 and the pivoting part 211. Alternatively, the driving unit 210 is a combination of power generator and power transmission elements, such as motor and gears or belts, for example, for providing power to enable the rotation of the first rotating element 214 thereby rotating the pivoting part 211 and following part 212 so that the size of the nozzle outlet 201 could be adjusted to control the water flow entering into the water wheel 22.

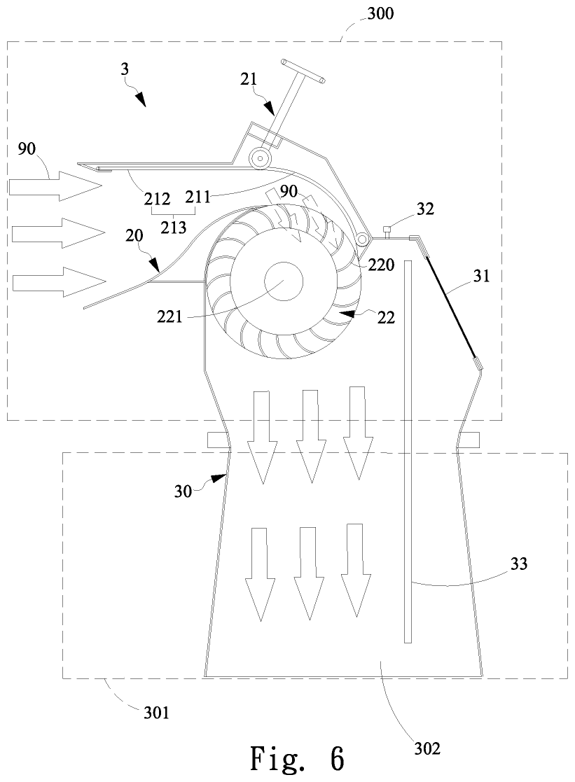

Please refer to FIG. 6, which illustrates a water turbine machine according to one embodiment of the present invention. In the present embodiment, the water wheel 22 of the water turbine machine 3 is a horizontal-axis cross-flow water wheel. The water turbine machine 3 comprises a housing 30 having an upper part 300 and a bottom part 301. The adjusting device 2 described previously is arranged inside the upper part 300 of the water turbine machine 3. An observation window made of transparent material such as glass, strengthen glass or transparent plastic, for example, is arranged at a side of the water wheel 22 whereby the operator could observe the operation status of the water wheel 22. In the present embodiment, the bottom part 301 is utilized as an exhausting pipe. The upper part 300 further comprises an adjusting knob 32 for adjusting the gas pressure and water level inside the exhausting pipe, i.e. bottom part 301. The water entering the water wheel 22 is finally exhausted from the exhausting channel 302 at the bottom of the bottom part 301. In addition, a communication pipe 33 is communicated with interior of the water turbine machine 3 through which the water level inside the water turbine machine 3 can be observed.

In one embodiment, the water flow 90 passes through the nozzle flow channel 20 of the water turbine machine 3 and enters into the water wheel 22. In the present embodiment, the water flow 90 impacts the blades 220 of the water wheel 22 so as to rotate the water wheel 22. It is noted that the shaft 221 of the water wheel 22 is coupled to a power generator. When the water wheel 22 is rotated, the shaft 221 transmission the rotating power to rotate the power generating module of the power generator thereby generating electrical power. It is noted that the combination of water turbine machine and power generator is well known by the one having ordinary skilled in the art, which is not further described hereinafter.

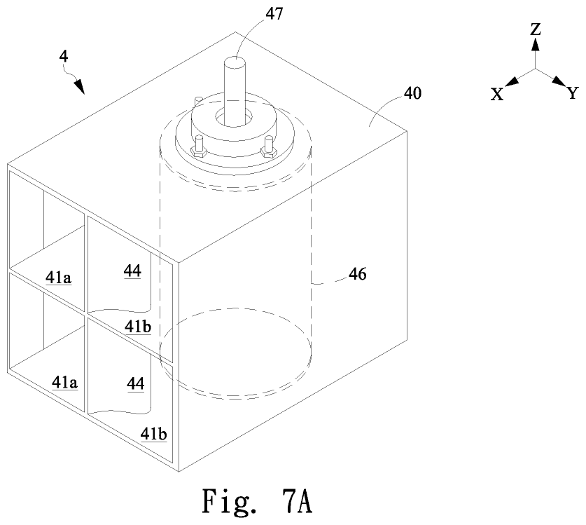

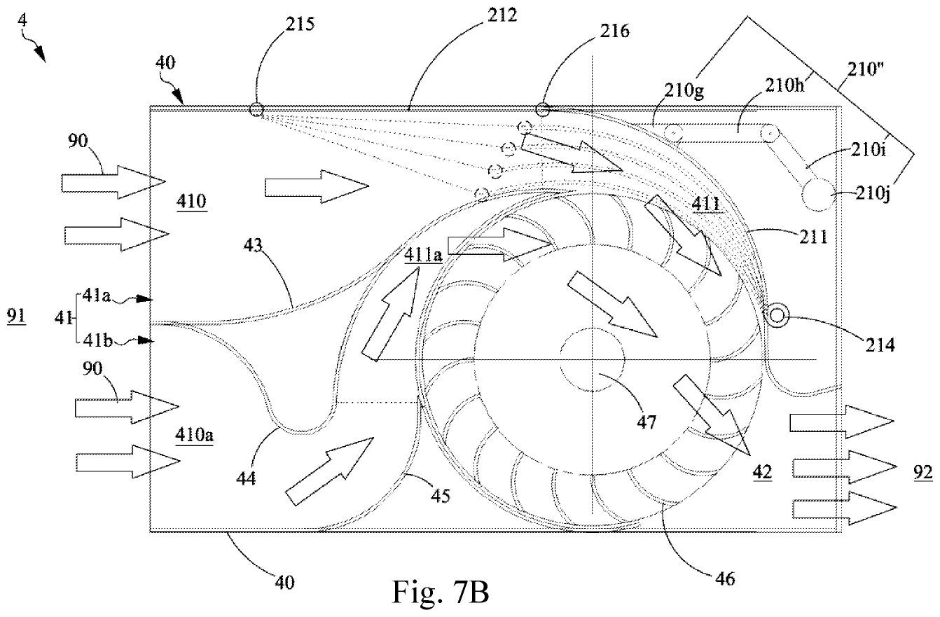

Please refer to FIGS. 7A and 7B, wherein FIG. 7A illustrates a vertical-axis cross-flow turbine according to one embodiment of the present invention, and FIG. 7B illustrates a XY plane cross-sectional view with respect to an application of the vertical-axis cross-flow turbine shown FIG. 7A. In the present embodiment, the water turbine machine 4 comprises a housing 40 having an upstream side 91 and downstream side 92. The upstream side 91 has a nozzle flow channel 41 arranged therein. The nozzle flow channel 41 is divided into upper flow channel and bottom flow channel along the Z direction, wherein the upper flow channel and bottom flow channel can be divided into a first nozzle flow channel 41a and a second nozzle flow channel 41b, respectively. In the present embodiment, first nozzle flow channel 41a has a water inlet 410 and a nozzle outlet 411, wherein the nozzle outlet 411 is corresponding to a part of the water wheel 46 arranged inside the housing 40. It is noted that the water wheel 46 is a vertical-axis cross-flow water wheel wherein the axial of the shaft 47 of the water wheel 46 is along the height direction Z of the water turbine machine 4.

In the present embodiment, an adjusting device for adjusting water flow is arranged at a lateral side of the first nozzle flow channel 41a. A part of the first nozzle flow channel 41a is formed by the pivoting part 211 and following part 212, wherein the pivoting part 211 can be manually or automatically driven to move through a driving unit 210″ so as to change the size of the nozzle outlet 411 thereby adjusting the water flow entering the water wheel 46. It is noted that the dashed lines shown in the FIG. 7B respectively represent the location of the pivoting part 211 and following part 212 which are driven by the driving unit 210″.

In the present embodiment, the driving unit 210″ comprises a power unit 210j, driving rod 210i, push rod 210h, and pivotal base 210g. The pivotal base 210g is arranged onto the pivoting part 211, the push rod 210h is pivotally coupled to the pivotal base 210g, wherein one end of the push rod 210h is rotated about an axis of the pivotal base 210g, and the other end of the push rod 210h is connected to the driving rod 210i whereby the driving rod 210i is capable of rotating about the axis of the connection part between the push rod 210h and driving rod 210i

The power unit 210j can be, but should not be limited to, motor, or combination of motor and belt, which is well known of one having ordinary skilled in the art. It is noted that the driving rod 210i and push rod 210h can be driven to rotate through the counterclockwise or clockwise rotation of the motor whereby the pivoting part 211 can be driven to rotate thereby controlling the opening size of the nozzle outlet 411. The operation of the pivoting part 211, driving part 212 and the driving unit 210″ are described previously, and it will not be described hereinafter. The nozzle flow channel 41b has a water inlet 410a and nozzle outlet 411a, wherein the nozzle outlet 411a is corresponding to a part of water wheel 46 arranged inside the housing 40.

The guiding plates 43 and 44 are arranged between the nozzle flow channels 41a and 41b, wherein the nozzle flow channel 41a are constituted by the guiding plate 43, the rotating plate 211 and the following plate 212, and the nozzle flow channel 41b is constituted by the guiding plate 44, a part of the housing 40, and the guiding plate 45. The water flow 90 enters the water turbine machine 4 through the nozzle flow channel 41a and 41b at upper flow channel and bottom flow channel and then enters the water wheel 46 thereby rotating the water wheel 46. The water flow 90 passes across the water wheel 46 and is exhausted from the water turbine machine 4 through the exhausting channel 42 corresponding to a part of the water wheel 46.

While the present invention has been particularly shown and described with reference to a preferred embodiment, it will be understood by those skilled in the art that various changes in form and detail may be without departing from the spirit and scope of the present invention.

What is claimed is:

1. A device for adjusting a water flow flowing into a water wheel, the device comprising:
a nozzle flow channel, having an inlet and a nozzle outlet corresponding to a part of the water wheel; and
an adjusting device, arranged at a side of the nozzle flow channel, for adjusting an opening dimension of the nozzle outlet, the adjusting device further comprising:
a pivoting part, having a first side coupled to a first rotating element through which the pivoting part rotates about a first axial direction for adjusting the opening dimension of the nozzle outlet;
a following part, having a third side rotatably coupled to a second side of the pivoting part, and a second rotating element arranged at a fourth side of the following part, wherein the second rotating element further moves along a second axial direction perpendicular to the first axial direction when the pivoting part changes the opening dimension of the nozzle outlet; and
a driving unit, utilized to generate a driving force for rotating the pivoting part.

2. The device of claim 1, wherein the driving unit further comprising:
a power unit;
a driving rod, coupled to the power unit; and
a connecting rod, having one end coupled to the driving rod, and the other end coupled to the pivoting part.

3. The device of claim 1, wherein the pivoting part has a curved part to completely cover the nozzle outlet so as to prevent the water flow flowing into the water wheel.

4. A water turbine machine, comprising:
a water wheel, arranged inside a housing, the water wheel has an axial shaft arranged along a first axial direction, whereby the water wheel rotates about the first axial direction;
a nozzle flow channel, having an inlet and a nozzle outlet corresponding to a part of the water wheel; and
an adjusting device, arranged at a side of the nozzle flow channel, for adjusting an opening dimension of the nozzle outlet, the adjusting device further comprising:
a pivoting part, having a first side coupled to a first rotating element through which the pivoting part rotates about the first axial direction for adjusting the opening dimension of the nozzle outlet;
a following part, having a third side rotatably coupled to a second side of the pivoting part, and a second rotating element arranged at a fourth side of the following part, wherein the second rotating element further moves along a second axial direction perpendicular to the first axial direction when the pivoting part changes the opening dimension of the nozzle outlet; and
a driving unit, utilized to generate a driving force for rotating the pivoting part.

5. The machine of claim 4, wherein the driving unit further comprising:
a power unit;
a driving rod, coupled to the power unit; and
a connecting rod, having one end coupled to the driving rod, and the other end coupled to the pivoting part.

6. The machine of claim 4, wherein the housing has an exhausting channel communicating with the nozzle outlet, and the exhausting channel is corresponding to the part of the water wheel wherein the water flow exhausted from the nozzle outlet flows into the water wheel, exerts force on the part of the water wheel thereby rotating the water wheel, and then enters the exhausting channel.

7. The machine of claim 4, wherein the pivoting part has a curved part to completely cover the nozzle outlet so as to prevent the water flow flowing into the water wheel.

8. The machine of claim 4, wherein the water wheel is a horizontal-axis water wheel or a vertical-axis water wheel.
